(19) United States
(12) Patent Application Publication
(10) Pub. No.: US 2011/0112904 A1
(43) Pub. Date: May 12, 2011

(54) Providing a recommendation based on a dietary preference

(76) Inventor: Steven Elliot Stupp, San Carlos, CA (US)

(21) Appl. No.: 12/927,371

(22) Filed: Nov. 12, 2010

Related U.S. Application Data
(60) Provisional application No. 61/281,074, filed on Nov. 12, 2009.

(51) Int. Cl. G06Q 30/00

(52) U.S. Cl. 705/14.58

(57) ABSTRACT

A computer system that provides a recommendation to a user based at least on one or more previously specified dietary preferences of the user and a current location of a portable electronic device, which is associated with a user, is described. This recommendation may include information associated with a subset of the food items available for purchase at the current location that are consistent with the previously specified dietary preferences, such as food items that include or exclude a particular constituent ingredient(s) and/or that have an appropriate nutritional information value(s). Note that the previously specified one or more dietary preferences may have been previously provided or selected by the user. Furthermore, when shopping in a grocery store, the current location may be provided via the portable electronic device, such as a cellular telephone, which displays the recommendation.

### CROSS REFERENCE TO RELATED APPLICATIONS

This application claims priority under 35 U.S.C. 119(e) to U.S. Provisional Application Ser. No. 61/281,074, entitled “Providing Recommendations Based on a Dietary Preference,” filed on Nov. 12, 2009, the contents of which are herein incorporated by reference.

### FIELD OF THE INVENTION

The present invention relates generally to an apparatus, and related methods, for providing a recommendation based at least on a dietary preference of a user.

### BACKGROUND

Many individuals have medical conditions that can be impacted by environmental factors, such as foods or beverages that are consumed (which are henceforth referred to as ‘food items’). For example, individuals with food allergies or sensitivities often need to avoid particular ingredients in food items that they consume. Similarly, individuals who are overweight, as well as those with hypertension or cardiovascular disease, may be affected by their: caloric, salt and/or fat intake. As a consequence, when shopping or at a restaurant these individuals may wish to base their purchasing decisions on the ingredients in food items, as well as on the nutritional information associated with these food items.

However, it can be difficult for individuals to access and use the available information for food items. For example, when shopping in a grocery store, reading the labels on multiple food items (such as packaged goods) can be time consuming and tedious. In addition, this approach can make it difficult for individuals to compare the ingredients and/or nutritional information for different food items with each other. Furthermore, when dining in a restaurant, the ingredients and nutritional information for food items in a menu may not be readily available, or may be posted at a remote location in the restaurant.

Therefore, there is a need for a recommendation technique to provide information about ingredients and/or nutritional information associated with food items without the problems listed above.

### SUMMARY OF THE INVENTION

One embodiment of the present invention describes a computer system that provides a recommendation. During operation, the computer system receives location information associated with a current location of a portable electronic device, which is associated with a user. Then, the computer system determines a subset of food items available for purchase at the current location that are consistent with at least one or more previously specified dietary preferences of the user based on constituent ingredients in the food items. Note that the determining involves accessing a food data structure, stored in a computer-readable medium, which includes at least some of the food items available for purchase at the current location and the constituent ingredients in the food items, and the subset of the food items includes one or more of the food items. Next, the computer system provides the recommendation, which includes information associated with the determined subset of the food items, to the portable electronic device.

In some embodiments, prior to receiving the location information, the computer system receives from the user the one or more dietary preferences. For example, receiving the one or more dietary preferences may involve user selection of one or more predefined dietary preferences. Furthermore, the one or more dietary preferences may include a constituent ingredient to avoid or to include in the subset of the foods items.

Additionally, the food data structure may include nutritional information associated with the food items. This nutritional information for the food items may be normalized based at least on associated manufacturers' suggested serving sizes for the food items and/or the portion sizes in one or more restaurants, thereby facilitating comparisons of the nutritional information for different food items. Moreover, the one or more dietary preferences may include a nutritional information value that exceeds a predetermined value or percentage, which is used to include or to exclude food items from the subset of the food items.

Note that the location information may be provided via the portable electronic device, such as a cellular telephone. For example, the location information may be determined using triangulation, trilateration and/or a positioning system. Furthermore, the current location may be in or proximate to a restaurant, or may be in or proximate to a grocery store. Alternatively or additionally, when shopping online, the current location may include a web page or website that may be associated with an online retail establishment and/or a restaurant.

In some embodiments, the recommendation includes advertising associated with a food item that is consistent with the one or more previously specified dietary preferences. For example, the advertising may present the food item along with other food items in the subset of the food items.

In some embodiments, the recommendation only includes the information associated with the determined subset of the food items.

Another embodiment provides a method that includes at least some of the operations performed by the computer system.

Another embodiment provides a computer-program product for use in conjunction with the computer system.

The disclosed embodiments facilitate providing one or more recommendations to a user based at least on the user's dietary preferences, thereby assisting the user in identifying food items to purchase.

### BRIEF DESCRIPTION OF THE DRAWINGS

FIG. 1 is a drawing of a system to provide a recommendation to a user in accordance with an embodiment.

FIG. 2 is a flow chart illustrating a process for providing the recommendation in accordance with an embodiment.

FIG. 3 is a block diagram illustrating a user interface that presents the recommendation in accordance with an embodiment.

FIG. 4 is a block diagram illustrating a computer system that performs the process of FIG. 2 in accordance with an embodiment.

FIG. 5 is a block diagram illustrating a data structure for use in the computer system of FIG. 4 in accordance with an embodiment.

Note that like reference numerals refer to corresponding parts throughout the drawings. Moreover, multiple instances of the same part are designated by a common prefix separated from an instance number by a dash.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

Embodiments of a computer system, a portable electronic device that interacts with the computer system, a method, a user interface, and a computer-program product (e.g., software) for use with the computer system and/or the portable electronic device are described. This computer system may provide a recommendation to a user, via the portable electronic device, based at least on one or more previously specified dietary preferences of the user and a current location of the portable electronic device, which is associated with a user. In particular, the recommendation may include information associated with a subset of the food items available for purchase at the current location that are consistent with the previously specified dietary preferences, such as food items that include or exclude a particular constituent ingredient(s) and/or that have an appropriate nutritional information value(s). Note that the previously specified one or more dietary preferences may have been previously provided or selected by the user. Furthermore, when shopping in a grocery store, the current location may be provided via the portable electronic device, such as a cellular telephone, which displays the recommendation. Alternatively, when shopping online, the current location may include a web page or website that may be associated with an online retail establishment and/or a restaurant. Subsequently, the portable electronic device may display the recommendation, for example, in a dialog box or a pop-up window in a Web browser.

By providing the information associated with the subset of the food items, this recommendation technique may provide actionable information to one or more users when the users are deciding which food items (and, more generally, which products) to purchase. In the process, the recommendation technique may facilitate the users' compliance with dietary restrictions associated with a disease and/or may assist the users in leading a healthier lifestyle.

In the discussion that follows, food items should be understood to include one or more foods and/or one or more beverages, such as packaged goods for sale in grocery store or supermarket, or items on a menu at a restaurant. These food items may be for sale at a retail establishment, which may include a physical or virtual (i.e., online) merchant that sells food items and/or a restaurant that sells food items (which may be consumed on the premises, eaten elsewhere or delivered to a consumer).

Furthermore, a given food item may include constituent ingredients, which in turn include fundamental ingredients. Constituent ingredients should be understood to be whole foods or ingredients that cannot be further decomposed into additional constituent ingredients. Based on this definition, constituent ingredients may include items such as egg white, egg yolk, carrots, milk, etc. However, constituent ingredients may also include chemicals, such as: extracts, milk protein, emulsifiers, antioxidants, preservatives, etc. Additionally, fundamental ingredients may be understood to include: fats (such as saturated fats and/or trans fats), carbohydrates, protein, and/or minerals. In general, constituent ingredients may include the items in a list of ingredients associated with a given food item (e.g. on the packing material), and fundamental ingredients may be included in the nutritional information for the given food item, as defined by the United States Department of Agriculture. Consequently, constituent ingredients may be understood to be those ingredients that cannot be further decomposed into other constituent ingredients and which are other than the fundamental ingredients in the nutritional information.

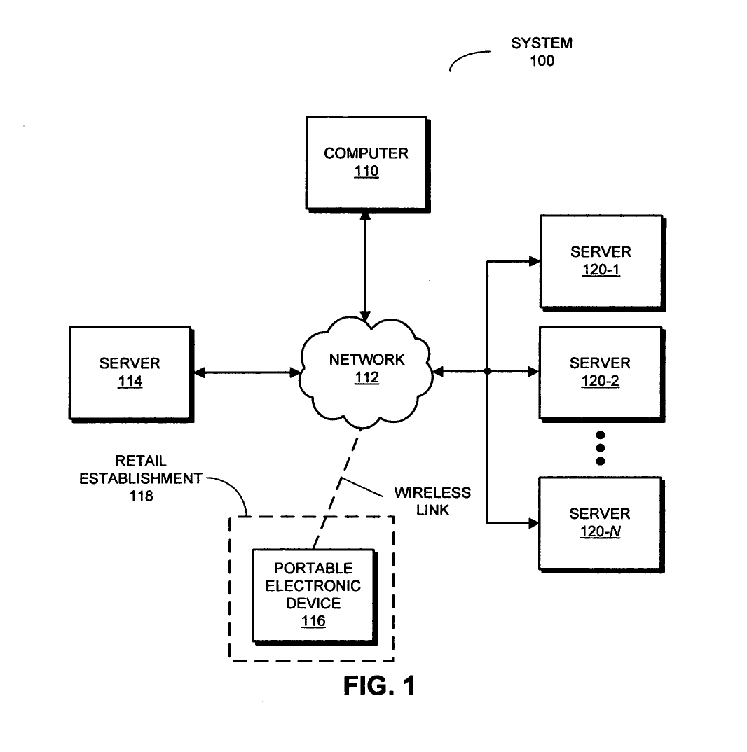

We now describe embodiments of a system that provides one or more recommendations to a user. FIG. 1 presents a drawing of a system 100 to provide one or more recommendations to the user. In this system, a user of computer 110 and/or portable electronic device 116 may provide one or more dietary preferences to server 114 via a network 112, such as the Internet. For example, the user may set up an account with a provider of the one or more recommendations, such as a host of server 114.

Subsequently, the user may be shopping for food items, for example, when dinning or ordering in a restaurant, or when shopping in a grocery store or a supermarket (or, more generally, when shopping in a retail establishment 118 that sells food items, which include one or more foods and/or one or more beverages). Using a portable electronic device 116 (such as a cellular telephone), the user may access server 114 via network 112 (which may include a wireless network). In the process, the user may provide location information that specifies (at least approximately) the current location of portable electronic device 116 in or proximate to retail establishment 118. For example, the location of portable electronic device 116 may be determined by network 112 using: triangulation, trilateration, a current cell being used in a cellular communication system, and/or another positioning technique (such as using a global or local positioning system). This location information may specify where the user is ‘shopping,’ such as the restaurant or the grocery store.

Alternatively or additionally, the user may provide at least a portion of the location information. For example, the user may select the restaurant or the grocery store from a list of options displayed on portable electronic device 116 that is provided by server 114 via network 112. In some embodiments, the user may verbally indicate a desired product or product category (such as a tomato soup or soup in general). Portable electronic device 116 may convert this instruction(s) into digital information using a voice recognition technique, and the digital information may be analyzed to determine the location information. Furthermore, the user may implicitly provide or supplement the location information, for example, by scanning a bar code on a packaged good in a particular department in the grocery store. Thus, if the user scans the bar code on a can soup (such as mushroom soup), or takes a picture of the bar code or the can (any of which may be performed using a camera on portable electronic device 116), this information may be communicated to server 114, which then specifies that the user is in or proximate to the soup section in the grocery store. Note that the user may or may not refine this information by specifying the grocery store.

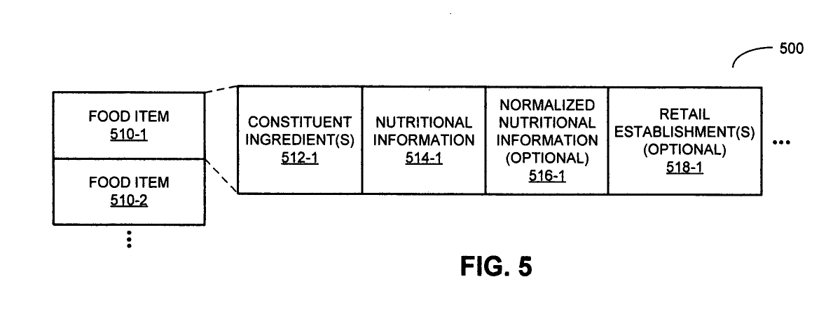

Then, based at least on the current location of portable electronic device 116 (and, thus, the user) and the one or more previously specified dietary preferences, server 114 may access a data structure with food items and their constituent ingredients, and may determine a subset of the food items that are consistent with the user's dietary preferences based on the constituent ingredients in the food items. This data structure (which is described further below with reference to FIG. 5) may include detailed information that is specific to the current location (such as at least some of the food items for sale at a particular grocery store or the current menu at a particular restaurant). Alternatively, the data structure may include food items that are available at multiple retail establishments, i.e., the data structure may not include information that is specific to the user's current location.

Next, information associated with this subset (or a top-N food items in the subset, where N is an integer) may be provided to the user in the form of the recommendation, which may be displayed on portable electronic device 116. For example, the information associated with the subset may include brand names of the food items and/or images of the packaged goods. Alternatively, the information in the recommendation may include menu items at a restaurant. For example, the recommendation may include the current menu at a particular restaurant, and food items on the menu, which are consistent with the one or more previously specified dietary preferences, may be highlighted.

In some embodiments, the recommendation includes advertising associated with a food item that is consistent with the one or more previously specified dietary preferences. For example, the advertising may present the food item along with other food items in the subset of the food items. However, in some embodiments the recommendation only includes the information associated with the determined subset of the food items (i.e., food items that are consistent with the previously specified dietary preferences).

In other embodiments, the user may shop for or order food items using computer 110 or portable electronic device 116. For example, the user may be shopping online. In these embodiments, the current location of the user may be a web page or website of an online retail establishment and/or a restaurant, which is hosted on one of servers 120. Furthermore, the location information may be provided to server 114 by computer 110 and/or portable electronic device 116 via network 112. This may be an explicit action by the user, such as if the user provides the location information. Alternatively or additionally, the location information may be provided implicitly, such as based on a cookie associated with the web page or website that is stored on computer 110 or portable electronic device 116, or via software installed on computer 110 or portable electronic device 116. This software may include a Web-browser plug-in that the user previously downloaded from server 114 via network 112. This Web-browser plug-in may determine the user's current location from the code associated with the web page or website (such HyperText Markup Language or Extensible Markup Language code) and/or from a Uniform Resource Locator associated with the web page or website, and may communicate this location information to server 114. Then, using the user's current (virtual) location and the one or more previously specified dietary preferences, server 114 may determine the subset of the food items and may provide the recommendation to the user for display on computer 110 or portable electronic device 116.

While the preceding embodiments illustrate the recommendation technique using a client-server architecture, in some embodiments at least a portion of the software that provides this service may be installed on computer 110 and/or portable electronic device 116. Thus, in some embodiments the recommendation may be provided to the user by a stand-alone application, such as recommendation software, or a portion of another application that is resident on and which executes on computer 110 and/or portable electronic device 116. Alternatively and/or additionally, at least a portion of the recommendation software or the other application may be a software application tool (provided by server 114 via network 112) that is embedded in a web page (and which executes in a virtual environment of a Web browser). In an illustrative embodiment, the software-application tool is a software package written in: JavaScript™ (a trademark of Oracle, Corp.), e.g., the software-application tool includes programs or procedures containing JavaScript instructions, ECMAScript (the specification for which is published by the European Computer Manufacturers Association International), VBScript™ (a trademark of Microsoft, Inc.) or any other client-side scripting language. In other words, the embedded software-application tool may include programs or procedures containing: JavaScript, ECMAScript instructions, VBScript instructions, or instructions in another programming language suitable for rendering by the Web browser or another client application on computer 110 and/or portable electronic device 116.

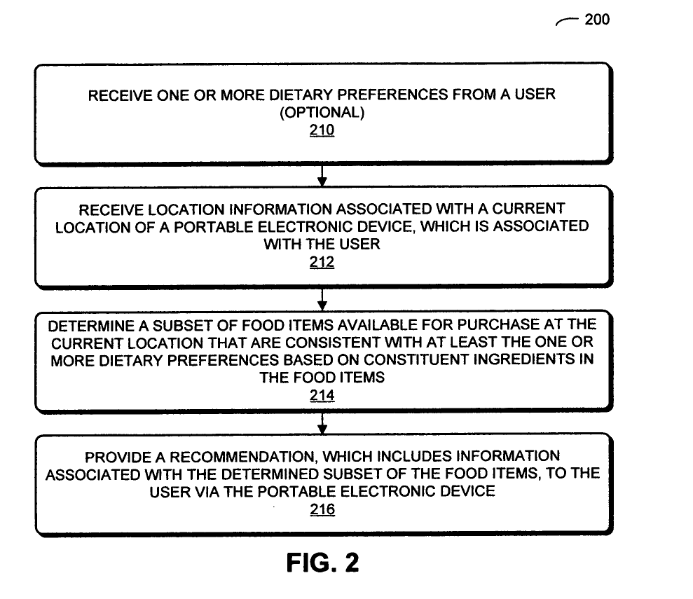

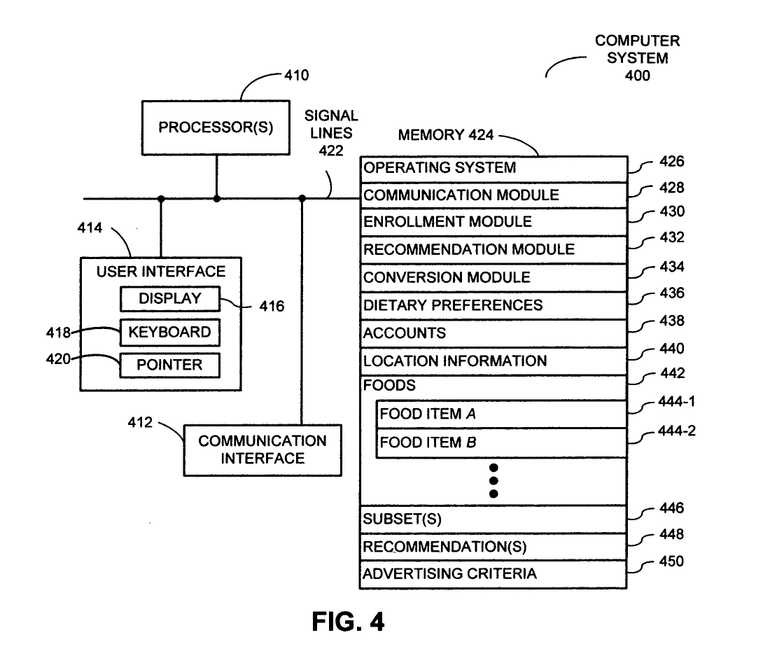

We now describe embodiments of a process for providing the recommendation. FIG. 2 presents a flow chart illustrating a process 200 for providing the recommendation, which may be performed by a computer system, such as computer system 400 in FIG. 4. During operation, the computer system receives location information associated with a current location of the portable electronic device (operation 212), which is associated with a user. Then, the computer system determines a subset of food items available for purchase at the current location that are consistent with at least one or more previously specified dietary preferences of the user based on constituent ingredients in the food items (operation 214). Note that the determining involves accessing a food data structure, stored in a computer-readable medium, which includes at least some of the food items available for purchase at the current location and the constituent ingredients in the food items, and the subset of the food items includes one or more of the food items. Next, the computer system provides the recommendation, which includes information associated with the determined subset of the food items, to the user (operation 216).

In some embodiments, prior to receiving the location information (operation 212), the computer system optionally receives from the user the one or more dietary preferences (operation 210). For example, receiving the one or more dietary preferences may involve user selection of one or more predefined dietary preferences, such as when the user sets up an account with a provider of the recommendation. Alternatively or additionally, the user may provide the one or more dietary preferences while they are at the current location, i.e., without previously setting up an account with the provider of the recommendation.

Note that the one or more previously specified dietary preferences may include a constituent ingredient to avoid or to include in the subset of the foods items. For example, the user may have a food allergy or a food sensitivity to a particular constituent ingredient, such as egg, and the one or more dietary preferences may specify that the user does not wish to consume egg. Alternatively, the user may wish to consume foods that include a particular constituent ingredient (such as apple or a fruit), which can be specified using the one or more dietary preferences.

Additionally, the food data structure may include nutritional information associated with the food items, such as: calories, fat, cholesterol, carbohydrates, protein, vitamins and/or minerals (i.e., the food data structure may include fundamental ingredients). This nutritional information for the food items may be normalized based at least on associated manufacturers' suggested serving sizes for the food items and/or the portion sizes in one or more restaurants, thereby facilitating comparisons of the nutritional information for different food items. Moreover, the one or more dietary preferences may include a nutritional information value that exceeds a predetermined value, which is used to include or to exclude food items from the subset of the food items. For example, the recommendation may include food items at the current location having less than 0.5 calories per gram (as opposed to 90 calories in a suggested serving size of 180 grams). Alternatively, the recommendation may include food items at the current location having 90 calories per suggested serving size. Furthermore, in some embodiments the recommendation may be based on an absolute nutritional information value, such as the total sodium in a dish or food item at a restaurant or the percentage of the daily recommended sodium intake in the dish or food item.

Note that the location information may be provided via the portable electronic device, such as a cellular telephone. For example, the location information may be determined using triangulation, trilateration and/or a positioning system. Furthermore, the current location may be in or proximate to a restaurant, or may be in or proximate to a grocery store. Alternatively or additionally, when shopping online, the current location may include a web page or website that may be associated with an online retail establishment and/or a restaurant.

In some embodiments, the recommendation includes advertising associated with a food item that is consistent with the one or more previously specified dietary preferences. For example, the advertising may present the food item along with other food items in the subset of the food items. Thus, the portable electronic device may include or highlight one or more particular foods items that are available for purchase and which meet the one or more previously specified dietary preferences. For example, the recommendation may include the top-5 best selling types of soup that are consistent with the one or more previously specified dietary preferences, as well as another type of soup that is not currently a best seller but which is consistent with the one or more previously specified dietary preferences. This service may provide a revenue stream for the provider of the recommendation, for example, packaged goods manufacturers may pay fees in exchange for this service.

Note that, in some embodiments, the recommendation only includes the information associated with the determined subset of the food items.

In some embodiments, process 200 includes additional or fewer operations. Moreover, the order of the operations may be changed and/or two or more operations may be combined into a single operation.

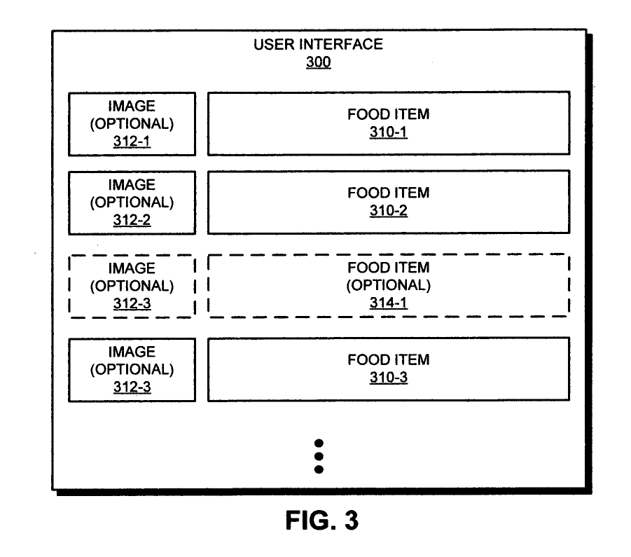

FIG. 3 presents a block diagram illustrating a user interface 300 that presents the recommendation. This user interface may include names of food items 310 in the subset of the food items, as well as optional images 312. Note that this focused presentation may assist the user in efficiently selecting food item(s) for purchase. Furthermore, if the user wishes to view more detailed information, the user may select one of food items 310, such as food item 310-1, for example, by touching on or proximate to food item 310-1 on a touch screen that displays user interface 300. In response, another user interface may be displayed with the constituent ingredients and/or nutritional information for food item 310-1. In this other user interface, constituent ingredients and/or nutritional information values that are consistent with the one or more previously specified dietary preferences may be highlighted. Subsequently, the user may activate an icon in the other user interface that restores the display of user interface 300.

In some embodiments, such as when the user is in a restaurant, food items 300 may be those on the current menu that are consistent with the one or more previously specified dietary preferences. Furthermore, in order to make it easier to find a particular food item (such as food item 310-1), user interface 300 may optionally include one or more additional food items, such as optional food item 314-1. Food items 310 and the optional additional food items may constitute the current menu at the restaurant, and user interface 300 may display this information in a format that resembles the current menu. To assist the user in selecting the appropriate food items, food items 310 may be highlighted relative to the optional additional food items (as indicated by the dashed lines for optional food item 314-1). Note that by touching user interface 300 on or proximate to a given food item in food items 310 or optional additional food item 314-1, the other user interface with the constituent ingredients and/or nutritional information values may be displayed, and the information that is consistent or inconsistent with the one or more previously specified dietary preferences may be highlighted. Thus, for food items 310 the information that is consistent may be highlighted, and for optional additional food item 314-1 the information that is inconsistent may be highlighted.

Alternatively, in some embodiments user interface 300 may only include the names of food items 310 and/or optional images 312. This focused presentation is simpler and may assist the user in selecting appropriate food items.

In an exemplary embodiment, the one or more previously specified dietary preferences include a constituent ingredient associated with an increase in the severity of a human disease in at least an individual when the individual is exposed to or consumes the constituent ingredient. Examples include: gluten for an individual with celiac disease; glycemic index or load for an individual with diabetes; salt for an individual with hypertension or a cardiac disease; artificial color, flavors and sweeteners for an individual with attention deficit hyperactivity disorder; a food trigger for migraine, asthma or a digestive disorder; a dietary restriction associated with a medicine (such as a monoamine oxidase inhibitor) currently prescribed to an individual; and/or sodium, protein and potassium for an individual with chronic kidney disease. In other embodiments, the one or more previously specified dietary preferences may broadly include a preference for: organic food items, vegetarian food items, vegan food items, low-carbohydrate food items, low-calorie food items, low-fat food items, food items that are heart healthy and/or food items that are nutritious (for example, food items other than processed foods). In some embodiments, the one or more previously specified dietary preferences indicate that an individual is dieting. In these embodiments, the recommendation may include and/or may be based on points or scores for the subset of the food items, such as those defined by Weight Watchers® (a trademark of Weight Watchers International, Inc., of New York, N.Y.).

We now describe embodiments of a computer system that may be included in system 100 (FIG. 1). FIG. 4 presents a block diagram illustrating a computer system 400 that performs process 200 (FIG. 2). Computer system 400 includes: one or more processors (or processor cores) 410, a communication interface 412, a user interface 414, and one or more signal lines 422 coupling these components together. Note that the one or more processors (or processor cores) 410 may support parallel processing and/or multi-threaded operation, the communication interface 412 may have a persistent communication connection, and the one or more signal lines 422 may constitute a communication bus. Moreover, the user interface 414 may include: a display 416, a keyboard 418, and/or a pointer 420, such as a mouse.

Memory 424 in the computer system 400 may include volatile memory and/or non-volatile memory. More specifically, memory 424 may include: ROM, RAM, EPROM, EEPROM, flash, one or more smart cards, one or more magnetic disc storage devices, and/or one or more optical storage devices. Memory 424 may store an operating system 426 that includes procedures (or a set of instructions) for handling various basic system services for performing hardware-dependent tasks. Moreover, memory 424 may also store communication procedures (or a set of instructions) in a communication module 428. These communication procedures may be used for communicating with one or more computers, devices and/or servers, including computers, devices and/or servers that are remotely located with respect to the computer system 400. While not shown in FIG. 4, in some embodiments memory 424 includes a Web browser (or a set of instructions).

Memory 424 may also include one or more program modules, including: enrollment module 430 (or a set of instructions), recommendation module 432 (or a set of instructions), and/or conversion module 434 (or a set of instructions). Note that one or more of these program modules (or sets of instructions) may constitute a computer-program mechanism.

By interacting with enrollment module 430 via communication interface 412 and communication module 428, a user may provide one or more dietary preferences 436 and/or may set up one of accounts 438.

Subsequently, when shopping in a retail establishment (either physically or virtually), the user or the user's portable electronic device (which may be a cellular telephone) may provide or determine location information 440 via communication interface 412 and communication module 428. In response, recommendation module 432 may access information about foods 442, such as food item A 444-1 and food item B 444-2. This information may include constituent ingredients in foods 442 and/or nutritional information associated with foods 442. Furthermore, the information about foods 442 may have been previously collected and stored, or may be dynamically collected (as needed) when location information 440 is received.

Using the food information, location information 440 and the one or more previously specified dietary preferences 436, recommendation module 432 may determine one or more subsets 446 of the food items and one or more associated recommendations 448. In some embodiments, recommendation module 432 may include food items in one or more of subsets 446 of the food items based at least on: one or more advertising criteria 450, the food information (such as the constituent ingredients and/or the nutritional information), location information 440 and the one or more previously specified dietary preferences 436. This recommendation(s) may be provided to the user, for example, using display 416.

In some embodiments, conversion module 434 may normalize nutritional information values for one or more of foods 442 based at least on manufacturer's suggested serving sizes for these food items and/or the portion sizes in one or more restaurants.

Instructions in the various modules in the memory 424 may be implemented in: a high-level procedural language, an object-oriented programming language, and/or in an assembly or machine language. The programming language may be compiled or interpreted, i.e., configurable or configured, to be executed by the one or more processors (or processor cores) 410.

Although the computer system 400 is illustrated as having a number of discrete components, FIG. 4 is intended to be a functional description of the various features that may be present in the computer system 400 rather than a structural schematic of the embodiments described herein. In practice, and as recognized by those of ordinary skill in the art, the functions of the computer system 400 may be distributed over a large number of servers or computers, with various groups of the servers or computers performing particular subsets of the functions. In some embodiments, some or all of the functionality of the computer system 400 may be implemented in one or more ASICs and/or one or more DSPs.

System 100 (FIG. 1), user interface 300 (FIG. 3) and/or computer system 400 may include fewer components or additional components. Moreover, two or more components may be combined into a single component and/or a position of one or more components may be changed. In some embodiments the functionality of system 100 (FIG. 1) and/or computer system 400 may be implemented more in hardware and less in software, or less in hardware and more in software, as is known in the art. Note that network 112 (FIG. 1) may include: a wired network, a wireless network, an optical network, the Internet, World Wide Web or WWW, an intranet, LAN, WAN, MAN, or combination of networks, or other technology enabling communication between electronic devices or computing systems.

We now describe embodiments of a data structure that may be used in computer system 400. FIG. 5 presents a block diagram illustrating a data structure 500. This data structure may include information associated with food items 510. For example, for food item 510-1, the information may include: constituent ingredients 512-1, nutritional information 514-1, optional normalized nutritional information 516-1 (which may be normalized based at least on a manufacturer's suggested serving size(s) and/or the portion size(s) in one or more restaurants), and/or one or more optional retail establishments 518-1 (or associated locations) that sell food item 510-1.

Note that in some embodiments of the data structure 500 there may be fewer or additional components. Moreover, two or more components may be combined into a single component and/or a position of one or more components may be changed.

While the preceding embodiments have used dietary preferences as an illustration, in other embodiments one or more recommendations may be provided to one or more users based at least on other or additional preferences, such as: environmentally friendly products (so-called ‘green’ products), products that don't include particular chemicals, etc. Furthermore, while preceding embodiments illustrated the recommendation technique in which a portable electronic device interacts with a computer system (or a server), in some embodiments some or all of the operations performed by the computer system in the preceding embodiments are performed by the portable electronic device.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed:

1. A computer-implemented method for providing a recommendation, comprising:
receiving location information associated with a current location of a portable electronic device, which is associated with a user;
determining, via a processor, a subset of food items available for purchase at the current location based at least on one or more previously specified dietary preferences of the user based on constituent ingredients in the food items, wherein the determining involves accessing a food data structure, stored in a computer-readable medium, which includes at least some of the food items available for purchase at the current location and constituent ingredients in the food items, and wherein the subset of the food items includes one or more of the food items; and
providing the recommendation, which includes information associated with the determined subset of the food items, to the portable electronic device.

2. The method of claim 1, prior to receiving the location information, the method further comprising receiving from the user the one or more dietary preferences.

3. The method of claim 2, wherein receiving the one or more dietary preferences involves user selection of one or more predefined dietary preferences.

4. The method of claim 1, wherein the one or more dietary preferences include a constituent ingredient to avoid in the subset of the foods items.

5. The method of claim 1, wherein the one or more dietary preferences include a constituent ingredient to include in the subset of the foods items.

6. The method of claim 1, wherein the food data structure includes nutritional information associated with the food items.

7. The method of claim 6, wherein the nutritional information for the food items is normalized based at least on associated manufacturers' suggested serving sizes for the food items.

8. The method of claim 6, wherein the one or more previously specified dietary preferences include a nutritional information value that exceeds a predetermined value, which can be used to include food items in the subset of the food items.

9. The method of claim 6, wherein the one or more previously specified dietary preferences include a nutritional information value that exceeds a predetermined value, which can be used to exclude food items from the subset of the food items.

10. The method of claim 1, wherein the location information is provided via the portable electronic device.

11. The method of claim 10, wherein the portable electronic device includes a cellular telephone.

12. The method of claim 10, wherein the current location is in or proximate to a restaurant.

13. The method of claim 10, wherein the current location is in or proximate to a grocery store.

14. The method of claim 1, wherein the current location includes a web page or website.

15. The method of claim 14, wherein the web page or website is associated with an online retail establishment.

16. The method of claim 14, wherein the web page or website is associated with a restaurant.

17. The method of claim 1, wherein the recommendation includes advertising associated with a food item that is consistent with the one or more previously specified dietary preferences.

18. The method of claim 1, wherein the recommendation only includes the information associated with the determined subset of the food items.

19. A computer-program product for use in conjunction with a computer system, the computer-program product comprising a computer-readable storage medium and a computer-program mechanism embedded therein for providing a recommendation, the computer-program mechanism including:
instructions for receiving location information associated with a current location of a portable electronic device, which is associated with a user;
instructions for determining a subset of food items available for purchase at the current location based at least on one or more previously specified dietary preferences of the user based on constituent ingredients in the food items, wherein the determining involves accessing a food data structure, stored in a computer-readable medium, which includes at least some of the food items available for purchase at the current location and constituent ingredients in the food items, and wherein the subset of the food items includes one or more of the food items; and
instructions for providing the recommendation, which includes information associated with the determined subset of the food items, to the portable electronic device.

20. A computer system, comprising:
a processor;
memory;
a program module, wherein the program module is stored in the memory and configurable to be executed by the processor, the program module including:
instructions for receiving location information associated with a current location of a portable electronic device, which is associated with a user;
instructions for determining a subset of food items available for purchase at the current location based at least on one or more previously specified dietary preferences of the user based on constituent ingredients in the food items, wherein the determining involves accessing a food data structure, stored in a computer-readable medium, which includes at least some of the food items available for purchase at the current location and constituent ingredients in the food items, and wherein the subset of the food items includes one or more of the food items; and
instructions for providing the recommendation, which includes information associated with the determined subset of the food items, to the portable electronic device.
